(19) United States
(12) Patent Application Publication
(10) Pub. No.: US 2022/0309321 A1
(43) Pub. Date: Sep. 29, 2022

(54) QUANTIZATION METHOD, QUANTIZATION DEVICE, AND RECORDING MEDIUM

(71) Applicant: Panasonic Intellectual Property Management Co., Ltd., Osaka (JP)

(72) Inventor: Norifumi MURATA, Osaka (JP)

(21) Appl. No.: 17/678,886

(22) Filed: Feb. 23, 2022

(30) Foreign Application Priority Data
Mar. 24, 2021 (JP) 2021-050388

(51) Int. Cl. G06N 3/04; G06N 5/04

(52) U.S. Cl. CPC G06N 3/04; G06N 5/046

(57) ABSTRACT

A quantization method executed by a computer includes: searching for quantization step sizes of parameters of a target layer by using a second inference contribution degree and quantization errors before and after quantization of the parameters of the target layer, the second inference contribution degree indicating a degree of influence of a layer next to the target layer and being obtained using a first inference contribution degree calculated in advance, the layer next to the target layer including second neurons as elements, and the first inference contribution degree indicating a degree of influence of each of layers that constitute a model composed of a neural network and each include first neurons as elements on an inference result obtained by using the model; and quantizing the parameters by using the quantization step sizes obtained as a result of the searching.

### CROSS REFERENCE TO RELATED APPLICATION

The present application is based on and claims priority of Japanese Patent Application No. 2021-050388 filed on Mar. 24, 2021.

### FIELD

The present disclosure relates to a quantization method for quantizing a model composed of a neural network, a quantization device, and a recording medium.

### BACKGROUND

An approach that uses deep learning in high accuracy recognition and prediction processing is attracting attention. The process of deep learning includes “training” and “inference” performed by using a model composed of a neural network.

In deep learning, in the case where high performance calculation resources can be used on a PC (Personal Computer), for example, training is performed by using a model with a parameter such as weight represented by a 32-bit floating point number (FP 32), and inference is performed by using the trained model.

In the case where limited calculation resources such as an embedded system are used, the training of a deep learning model is performed on a PC in advance. On the other hand, inference is performed by using the trained model with the FP 32 parameter that has been quantized to an integer parameter such as, for example, INT 8 or INT 16.

However, with the simple quantization conversion that equidistantly quantizes the resolution of the FP 32 parameter to a parameter such as INT 8 or INT 16, degradation occurs in the inference accuracy. To address this, a method for preventing degradation in the inference accuracy by performing quantization so as to reduce errors (quantization errors) caused by the quantization has been proposed (see, for example, Patent Literature (PTL) 1).

### CITATION LIST

### Patent Literature

PTL 1: Japanese Unexamined Patent Application Publication No. 2020-177535

### SUMMARY

However, the method for preventing degradation in the inference accuracy according to PTL 1 can be improved upon.

In view of this, the present disclosure provides a quantization method and the like capable of improving upon the above related art.

A quantization method according to one embodiment of the present disclosure is a quantization method executed by a computer, the quantization method including: searching for quantization step sizes of a plurality of parameters of a target layer by using a second inference contribution degree and quantization errors before and after quantization of the plurality of parameters of the target layer, the second inference contribution degree indicating a degree of influence of a layer next to the target layer and being obtained using a first inference contribution degree calculated in advance, the layer next to the target layer including a plurality of second neurons as elements, the first inference contribution degree indicating a degree of influence of each of a plurality of layers that constitute a model composed of a neural network and each include a plurality of first neurons as elements on an inference result obtained by using the model, and the target layer and the layer next to the target layer being included in the plurality of layers; and quantizing the plurality of parameters by using the quantization step sizes obtained as a result of the searching.

General and specific aspects disclosed above may be implemented using a system, a method, an integrated circuit, a computer program, or a computer-readable recording medium such as a CD-ROM, or any combination of systems, methods, integrated circuits, computer programs, or computer-readable recording media.

A quantization method according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing a functional configuration of a quantization device according to an embodiment.

FIG. 2 is a diagram showing an example of a hardware configuration of a computer that implements the functions of the quantization device according to the embodiment by using software.

FIG. 3 is a diagram showing an example of a quantization target model and parameters according to the embodiment.

FIG. 4A is a diagram illustrating an example of a method for calculating an inference contribution degree according to the embodiment.

FIG. 4B is a diagram illustrating the example of the method for calculating an inference contribution degree according to the embodiment.

FIG. 4C is a diagram illustrating the example of the method for calculating an inference contribution degree according to the embodiment.

FIG. 5 is a diagram illustrating another example of the method for calculating an inference contribution degree according to the embodiment.

FIG. 6 is a diagram illustrating quantization processing according to the embodiment.

FIG. 7 is a diagram showing an example of an inference contribution degree acquired by an evaluation calculator according to the embodiment.

FIG. 8A is a diagram showing parameter values before quantization calculated by the evaluation calculator according to the embodiment.

FIG. 8B is a diagram showing parameter values after quantization calculated by the evaluation calculator according to the embodiment.

FIG. 9 is a diagram illustrating a method for determining an optimal quantization step size according to the embodiment.

FIG. 10 is a flowchart illustrating an overall operation performed by a quantization device according to the embodiment.

FIG. 11 is a flowchart illustrating an example of a detailed operation performed by the quantization device according to the embodiment.

FIG. 12 is a flowchart illustrating an example of a specific operation performed in step S11 shown in FIG. 11.

FIG. 13 is a flowchart illustrating an example of a specific operation performed in step S13 shown in FIG. 11.

FIG. 14 is a flowchart illustrating an example of a specific operation performed in step S14 shown in FIG. 11.

FIG. 15 is a diagram showing an example of a quantization target model.

FIG. 16A is a diagram illustrating a quantization method according to a comparative example.

FIG. 16B is a diagram illustrating the quantization method according to the comparative example.

FIG. 16C is a diagram illustrating the quantization method according to the comparative example.

FIG. 16D is a diagram illustrating the quantization method according to the comparative example.

FIG. 17 is a diagram conceptually illustrating a quantization method according to the embodiment.

### DESCRIPTION OF EMBODIMENT

### (Underlying Knowledge Forming the Basis of the Present Disclosure)

The inventors of the present application found that the following disadvantage occurs in the method for preventing degradation in the inference accuracy according to PTL 1 that was described in the Background section.

That is, in the method for preventing degradation in the inference accuracy according to PTL 1, even when quantization is performed so as to reduce a portion with a large quantization error to be small, it is not always possible to prevent the degradation in the inference accuracy. There are cases where even when there is a large quantization error, the quantization error does not significantly contribute to the inference accuracy and where although the quantization error is relatively small, the quantization error significantly contributes to the inference accuracy.

As described above, there is a disadvantage in that, when quantization is performed, it is possible to reduce the amount of computation required to perform inference using a model, but the inference accuracy may be degraded.

In order to address the disadvantage described above, a quantization method according to one aspect of the present disclosure is a quantization method executed by a computer, the quantization method including: searching for quantization step sizes of a plurality of parameters of a target layer by using a second inference contribution degree and quantization errors before and after quantization of the plurality of parameters of the target layer, the second inference contribution degree indicating a degree of influence of a layer next to the target layer and being obtained using a first inference contribution degree calculated in advance, the layer next to the target layer including a plurality of second neurons as elements, the first inference contribution degree indicating a degree of influence of each of a plurality of layers that constitute a model composed of a neural network and each include a plurality of first neurons as elements on an inference result obtained by using the model, and the target layer and the layer next to the target layer being included in the plurality of layers; and quantizing the plurality of parameters by using the quantization step sizes obtained as a result of the searching.

With the quantization method described above, the step size can be determined so as to minimize the quantization error of a neuron with a large inference contribution degree. Accordingly, there is a possibility that the degradation in the inference accuracy can be prevented even when quantization is performed on the model composed of a neural network.

Also, for example, the searching for the quantization step sizes of the plurality of parameters may be performed by using an evaluation equation including a product value of the quantization errors and the second inference contribution degree such that the evaluation equation is minimized.

With this configuration, there is a possibility that an optimal quantization step size can be determined for a parameter of the target layer of the model.

Also, for example, the quantization method may further include: calculating first neuron values of the first neurons by performing inference by inputting, to the model, each item of data that constitutes an inference contribution degree calculation dataset that is at least a portion of a training dataset used to train the model; calculating, for each of the first neurons, an accumulated value by accumulating the first neuron values calculated for all items of the data that constitutes the inference contribution degree calculation dataset; and calculating, as the first inference contribution degree, a value obtained by normalizing the accumulated value of each of the first neurons for each of the plurality of layers.

With this configuration, there is a possibility that the inference contribution degree can be calculated for each of the plurality of neurons of the target layer and the layer next to the target layer.

Here, for example, the plurality of parameters may be at least either a plurality of intermediate values of the target layer or a plurality of weights assigned to the second neurons.

Also, for example, the model may be a convolutional neural network, and the intermediate values may be feature maps of the target layer.

Also, a quantization device according to one aspect of the present disclosure is a quantization device including: a processor; and a memory, wherein the processor performs the following by using the memory: searching for quantization step sizes of a plurality of parameters of a target layer by using a second inference contribution degree and quantization errors before and after quantization of the plurality of parameters of the target layer, the second inference contribution degree indicating a degree of influence of a layer next to the target layer and being obtained using a first inference contribution degree calculated in advance, the layer next to the target layer including a plurality of second neurons as elements, the first inference contribution degree indicating a degree of influence of each of a plurality of layers that constitute a model composed of a neural network and each include a plurality of first neurons as elements on an inference result obtained by using the model, and the target layer and the layer next to the target layer being included in the plurality of layers; and quantizing the plurality of parameters by using the quantization step sizes obtained as a result of the searching.

Hereinafter, an embodiment of the present disclosure will be described in detail with reference to the drawings. The embodiment described below shows a specific example of the present disclosure. The numerical values, shapes, materials, standards, structural elements, the arrangement and connection of the structural elements, steps, the order of the steps, and the like shown in the following embodiment are merely examples, and therefore are not intended to limit the scope of the present disclosure. Also, among the structural elements described in the following embodiment, structural elements not recited in any one of the independent claims are described as arbitrary structural elements. Also, the diagrams are not necessarily true to scale. In the diagrams, structural elements that are substantially the same are given the same reference numerals, and a redundant description may be omitted or simplified.

### Embodiment

A quantization method and a quantization device according to the present embodiment will be described first.

### 1. Quantization Device 10

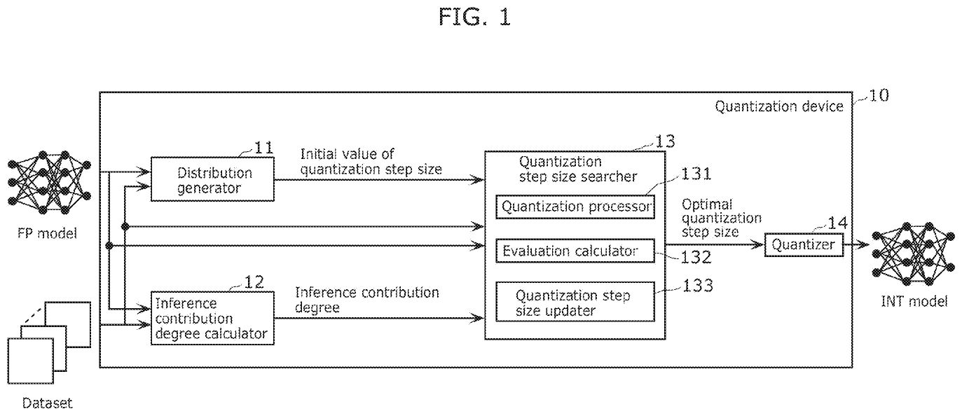

Hereinafter, a configuration and the like of quantization device 10 according to the present embodiment will be described. FIG. 1 is a block diagram showing a functional configuration of quantization device 10 according to the present embodiment.

Quantization device 10 is implemented by using a computer or the like, and is a device used to search for an optimal quantization step size that can prevent degradation in inference accuracy even when the parameters of a model composed of a neural network are quantized. The model may be a fully-connected neural network model or a convolutional neural network.

In the present embodiment, as shown in FIG. 1, quantization device 10 includes distribution generator 11, inference contribution degree calculator 12, quantization step size searcher 13, and quantizer 14. Quantization device 10 does not necessarily need to include quantizer 14.

An FP model that is input to quantization device 10 is a model that is composed of a neural network that includes a parameter represented by FP 32. FIG. 1 shows a four-layer model that is composed of four layers. A dataset that is input to quantization device 10 is at least a portion of a training dataset that was used to train the FP model. An INT model that is output from quantization device 10 is a model whose parameter represented by FP 32 of the FP model has been quantized to an integer parameter. The INT model may be a model whose parameter represented by a floating point number of the FP model has been quantized to, for example, a parameter represented by a fixed point number.

In the present embodiment, the parameter includes at least either intermediate values (neuron values) of a quantization target layer in the model or weights of the target layer. The intermediate values may also be referred to as “activation”. Also, if the target layer is a convolution layer, the intermediate values may also be referred to as “feature maps”.

### [1-1. Hardware Configuration]

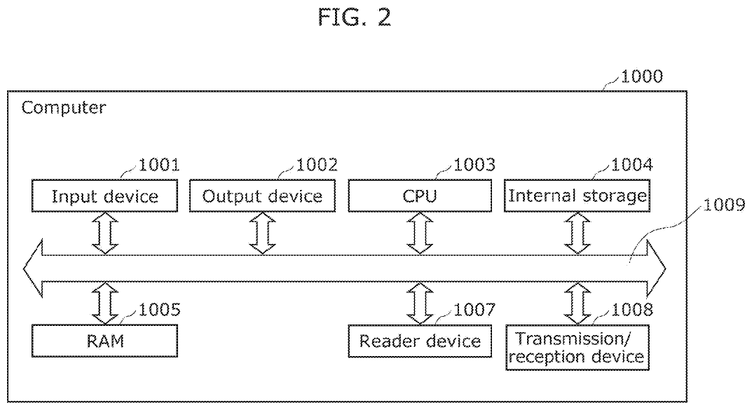

Prior to describing a functional configuration of quantization device 10 according to the present embodiment, an example of a hardware configuration of quantization device 10 according to the present embodiment will be described with reference to FIG. 2.

FIG. 2 is a diagram showing an example of a hardware configuration of computer 1000 that implements the functions of quantization device 10 according to the present embodiment by using software.

As shown in FIG. 2, computer 1000 is a computer that includes input device 1001, output device 1002, CPU 1003, internal storage 1004, RAM 1005, reader device 1007, transmission/reception device 1008, and bus 1009. Input device 1001, output device 1002, CPU 1003, internal storage 1004, RAM 1005, reader device 1007, and transmission/reception device 1008 are connected by bus 1009.

Input device 1001 is a device that serves as a user interface such as an input button, a touch pad, or a touch panel display, and is configured to receive user's operations. Input device 1001 may be configured to receive, in addition to user's touch operations, voice operations, remote operations using a remote controller, and the like.

Output device 1002 is, for example, a touch pad, a touch panel device, or the like that also functions as input device 1001, and is configured to notify a user of information that the user needs to know.

Internal storage 1004 is a flash memory or the like. Also, internal storage 1004 may store, in advance, at least one of a program for implementing the functions of quantization device 10 or an application that uses the functional configuration of quantization device 10. Also, internal storage 1004 may be configured to store the input FP model, the INT model that has been quantized by quantization step size searcher 13, an evaluation equation for use in evaluation calculation, and the initial value and the updated value of the quantization step size.

RAM 1005 is a random access memory, and is used to store data and the like when the program or the application is executed.

Reader device 1007 reads information from a recording medium such as a USB (Universal Serial Bus) memory. Reader device 1007 reads the program or the application as described above from the recording medium in which the program and the application are recorded, and stores the program or the application in internal storage 1004.

Transmission/reception device 1008 is a communication circuit for performing wireless or wired communication. Transmission/reception device 1008 may perform communication with, for example, a server device that is connected to a network, download the program or the application as described above from the server device, and store the program or the application in internal storage 1004.

CPU 1003 is a central processing unit, and is configured to copy the program or the application stored in internal storage 1004 into RAM 1005, sequentially read instructions that are included in the program or the application from RAM 1005, and execute the instructions.

Next, a functional configuration of quantization device 10 according to the present embodiment shown in FIG. 1 will be described.

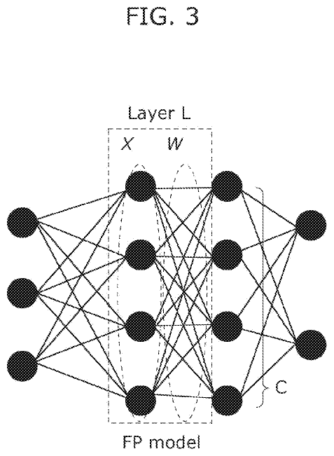

FIG. 3 is a diagram showing an example of a quantization target model and parameters according to the present embodiment. The following description will be given by using a trained FP model as shown in FIG. 3 that is composed of four layers including an input layer composed of three neurons, an intermediate layer including two layers each composed of four neurons, and an output layer composed of two neurons. Also, in FIG. 3, layer L is a quantization target layer, and X and W of layer L are parameters to be quantized. X is a neuron value (distribution) of layer L, and may be a feature map. Also, W is a weight (distribution) of layer L, and may be a filter. C represents the inference contribution degree of a layer next to the target layer, which will be described later.

### [1-2. Distribution Generator 11]

Distribution generator 11 generates distributions of the parameters of the target layer that is the quantization target in the input FP model. In the present embodiment, distribution generator 11 generates a weight distribution of the target layer, specifically, a distribution of a plurality of weights assigned to a plurality of neurons that constitute the target layer. Also, distribution generator 11 generates an intermediate value distribution of the target layer, specifically, a distribution of neuron values (intermediate values) of the plurality of neurons that constitute the target layer.

For example, the weight distribution of the target layer is a bell-shaped distribution in which a plurality of weight values assigned to the plurality of neurons that constitute the target layer are shown in the shape of a bell, with the horizontal axis indicating neuro-index, and the vertical axis indicating weight value. Also, distribution generator 11 inputs a dataset to the FP model, calculates neuron values (intermediate values) of the plurality of neurons that constitute the target layer, and thereby generates the intermediate value distribution of the target layer. The intermediate value distribution of the target layer is also a bell-shaped distribution in which the intermediate values are shown in the shape of a bell, with the horizontal axis indicating neuro-index, and the vertical axis indicating intermediate value.

The dataset used by distribution generator 11 may be a training dataset, or distribution generation dataset obtained by extracting a portion of the training dataset.

Also, distribution generator 11 calculates the initial value of the quantization step size based on the intermediate value distribution and the weight distribution of the target layer that were generated, and outputs the calculated initial value to quantization step size searcher 13.

### [1-3. Inference Contribution Degree Calculator 12]

Inference contribution degree calculator 12 calculates the inference contribution degree of a plurality of neurons of a layer next to the quantization target layer. Here, inference contribution degree calculator 12 quantifies and calculates the inference contribution degree of the layer next to the target layer by using, for example, a method for quantifying and visualizing the degree of influence on the result of inference such as Grad-CAM (Gradient-weighted Class Activation Mapping). Grad-CAM is a method with which it is possible to specify a feature to which a model composed of a neural network is giving attention. The method for quantifying and visualizing the degree of influence on the result of inference is not limited to Grad-CAM, and it is also possible to use CAM (Class activation map), Guided Grad-CAM, or Guided Backpropagation.

For example, first, inference contribution degree calculator 12 calculates an inference contribution degree (first inference contribution degree) on a result of inference obtained by using a model composed of a neural network, the inference contribution degree indicating the degree of influence of each of a plurality of layers including a plurality of first neurons as elements in each of the plurality of layers that constitute the model. More specifically, inference contribution degree calculator 12 calculates first neuron values that are the values of the first neurons by inputting, to the model, each of data constituting an inference contribution degree calculation dataset that is at least a portion of the training dataset used to train the model and performing inference. Next, inference contribution degree calculator 12 calculates accumulated values by accumulating the first neuron values calculated for all data that constitute the inference contribution degree calculation dataset. Then, inference contribution degree calculator 12 calculates values by normalizing the accumulated values of the first neurons in each of the plurality of layers, as the first inference contribution degree. In the present embodiment, inference contribution degree calculator 12 sequentially inputs each data of the dataset to the FP model, sequentially calculates the neuron values (intermediate values) of a plurality of neurons that constitute each layer of the intermediate layer, and accumulates the calculated neuron values for each neuron in the intermediate layer. Then, inference contribution degree calculator 12 normalizes the accumulated neuron values for each layer, and obtains the values of the neurons that constitute the intermediate layer of the normalized FP model, as the first inference contribution degree. The dataset used by inference contribution degree calculator 12 may be a training dataset or an inference contribution degree calculation dataset obtained by extracting a portion of the training dataset.

Next, for example, inference contribution degree calculator 12 calculates an inference contribution degree (second inference contribution degree) by using the calculated first inference contribution degree, the inference contribution degree indicating the degree of influence of the layer next to the target layer, the next layer including a plurality of second neurons as elements. In the present embodiment, inference contribution degree calculator 12 may obtain, from among the values of the neurons of the intermediate layer of the FP model obtained by normalizing the accumulated neuron values for each layer, the neuron values of the plurality of neurons that constitute the layer next to the target layer, as the second inference contribution degree.

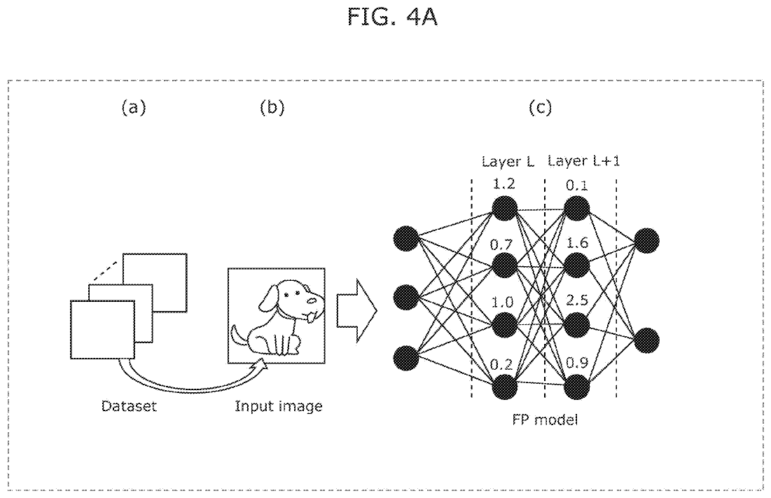

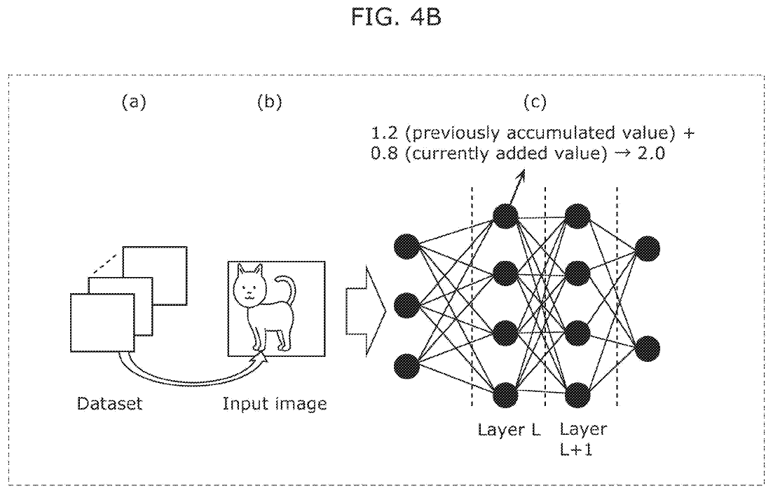

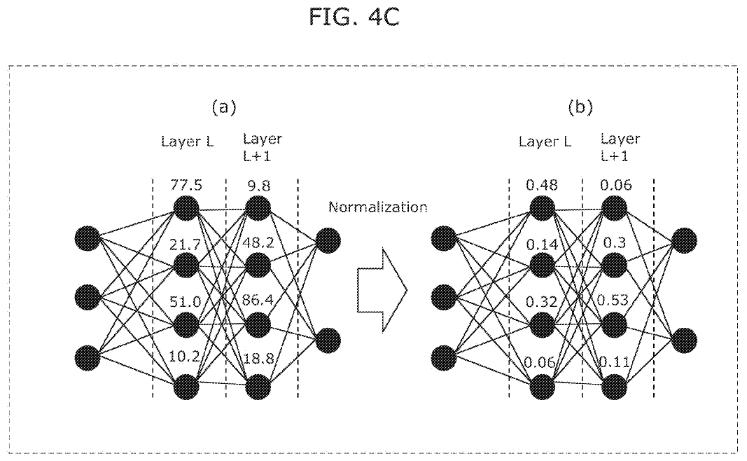

Here, the concept of the method for calculating inference contribution degree will be described with reference to FIGS. 4A to 4C.

FIGS. 4A to 4C are diagrams illustrating an example of the method for calculating inference contribution degree according to the present embodiment. The datasets that are shown in (a) in FIG. 4A and (a) in FIG. 4B may be training datasets as described above, or may be inference contribution degree calculation datasets. Also, in FIGS. 4A to 4C, layer L is the target layer, and layer L+1 is the layer next to the target layer.

As shown in FIG. 4A, first, a single item of data is input to an FP model from the dataset as shown (a) in FIG. 4A. As shown in (c) in FIG. 4A, neuron values are calculated for each layer. In the example shown in (b) in FIG. 4A, the single item of data is image data that includes a dog.

Next, as shown in FIG. 4B, another single item of data is input to the FP model from the dataset shown in (a) in FIG. 4B. As shown in (c) in FIG. 4B, neuron values are calculated for each layer, and the calculated neuron values are accumulated for each neuron. (c) in FIG. 4B shows an example in which the top neuron of layer L has an accumulated value of 2.0. In the example shown in FIG. 4B, the single item of data is image data that includes a cat.

Next, the remaining items of data included in the dataset are sequentially input to the FP model to calculate accumulated values by accumulating, for each neuron, neuron values calculated for all items of data included in the dataset, and normalize the accumulated values. (a) in FIG. 4C shows accumulated values for each of the neurons included in layer L and layer L+1. (b) in FIG. 4C shows values of the neurons obtained by normalizing the accumulated values for each layer, or in other words, for each of layer L and layer L+1. In (b) in FIG. 4C, for example, values each obtained by dividing the accumulated value of each neuron of layer L by 160.4 that is the total of the accumulated values of layer L are defined as the values obtained by normalizing the accumulated values of layer L. Then, the values shown in (b) in FIG. 4C, or in other words, the values of the neurons obtained by normalization may be used as the inference contribution degree.

In the manner described above, inference contribution degree calculator 12 calculates the inference contribution degree of each of the plurality of neurons in each of the target layer and the next layer.

FIGS. 4A to 4C have been described by using an example in which a fully-connected neural network is used as an example of the FP model, but the present embodiment is not limited thereto. The FP model may be a convolutional neural network (CNN) model that is useful in image recognition, or may be a neural network model that partially includes a convolution layer. In this case, the neuron values described above are calculated as feature maps. That is, in the case where the model is a convolutional neural network, the intermediate values are feature maps of the target layer.

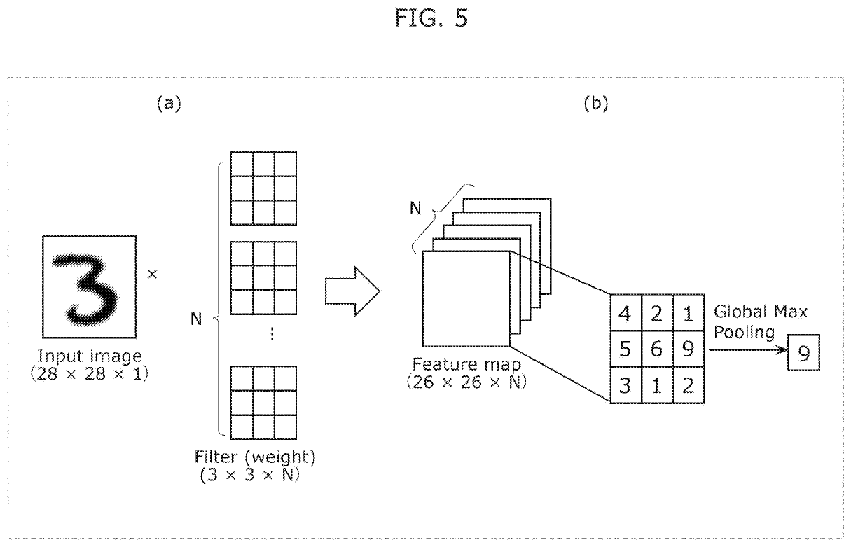

FIG. 5 is a diagram illustrating another example of the method for calculating inference contribution degree according to the present embodiment. FIG. 5 shows an example in which one of the intermediate layers is a convolution layer. The convolution layer outputs, for example, feature maps obtained by extracting a plurality of features from an input image of (28×28×1) dimension by using (3×3) N filters (weights). N is referred to as “channel”. In the example shown in FIG. 5, values obtained by applying Global Max Pooling (GMP) to each of N (26×26) feature maps obtained as an intermediate layer are calculated as intermediate values (neuron values) described above. By doing so, in the same manner as described above, the intermediate values can be calculated and accumulated for all items of data included in the dataset, and normalized, and thus the inference contribution degree of the feature maps can be calculated.

### [1-3. Quantization Step Size Searcher 13]

Quantization step size searcher 13 searches for quantization step sizes of a plurality of parameters by using the inference contribution degree (second inference contribution degree) of the layer next to the target layer and the quantization errors before and after the quantization of the plurality of parameters of the target layer. Quantization step size searcher 13 searches for quantization step sizes of a plurality of parameters by using an evaluation equation composed of product values of the quantization errors and the second inference contribution degree, such that the evaluation equation is minimized.

In the present embodiment, as shown in FIG. 1, quantization step size searcher 13 includes quantization processor 131, evaluation calculator 132, and quantization step size updater 133.

### <Quantization Processor 131>

Quantization processor 131 quantizes the parameters of the target layer by using the initial value or the updated value of the quantization step size. The target layer is not necessarily limited to a specific layer, and may be all layers of the FP model. Also, in the case where quantization processor 131 quantizes the feature maps as the intermediate values, the quantization is not necessarily performed on a feature map basis, and the quantization may be performed on a channel basis (for each of N channels shown in FIG. 5) by taking the calculation cost into consideration.

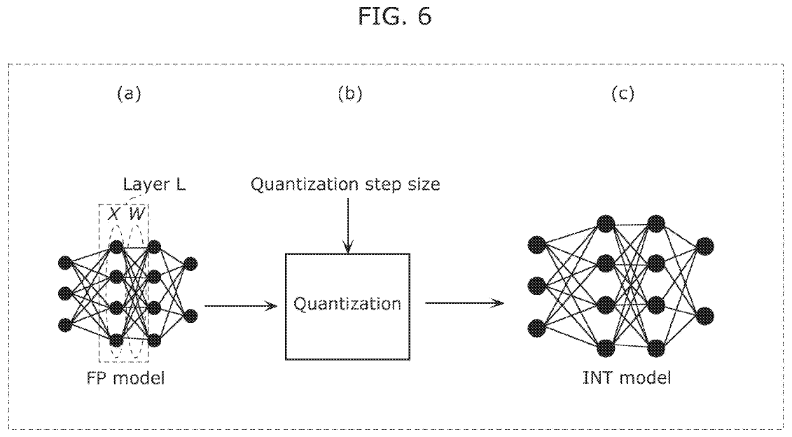

FIG. 6 is a diagram illustrating quantization processing according to the present embodiment.

That is, quantization processor 131 quantizes parameters X and W of layer L of an FP model shown in (a) in FIG. 6 by using an initial or updated quantization step size value in (b) in FIG. 6, and obtains an INT model shown in (c) in FIG. 6.

### <Evaluation Calculator 132>

Evaluation calculator 132 has acquired in advance the inference contribution degree of the layer next to the target layer from inference contribution degree calculator 12. Evaluation calculator 132 calculates parameter values before and after quantization obtained by sequentially inputting each item of data that constitutes an evaluation calculation dataset that is at least a portion of the training dataset to the FP model and the INT model. Evaluation calculator 132 calculates an evaluation result by using the calculated parameter values before and after quantization, the acquired inference contribution degree, and a quantization step size evaluation equation.

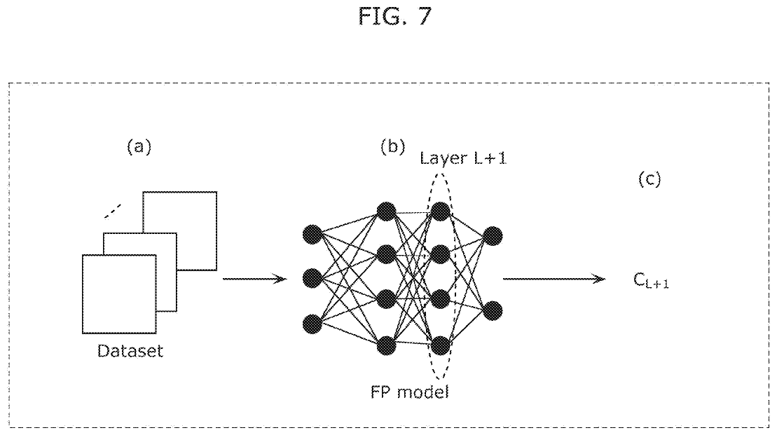

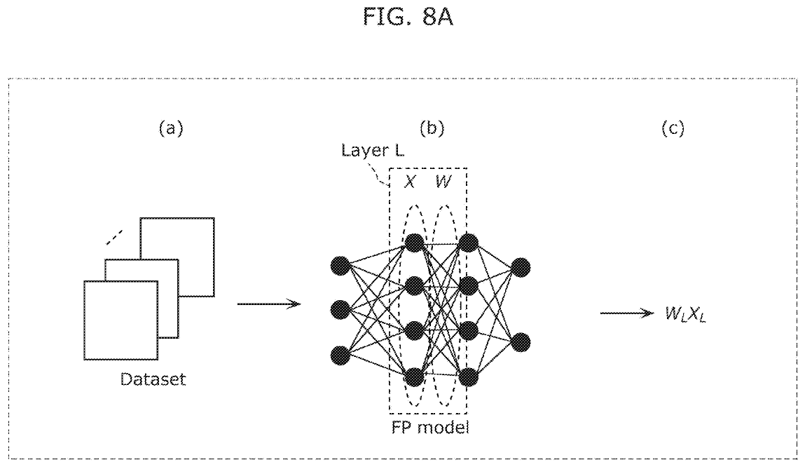

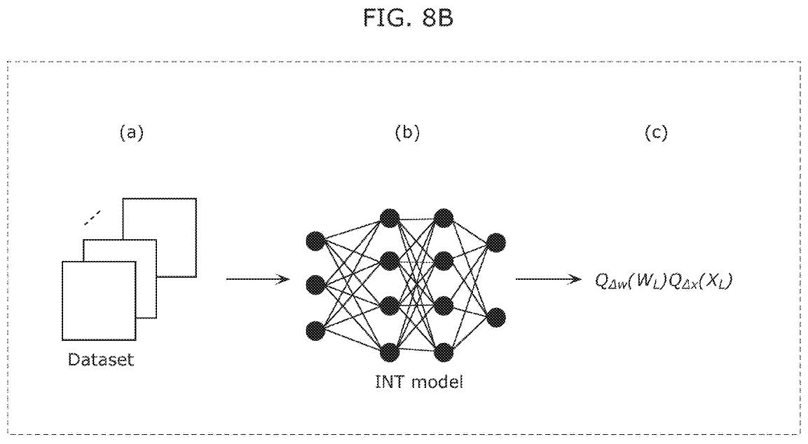

FIGS. 7 to 8B are diagrams illustrating a method for calculating an evaluation rating for quantization step size according to the present embodiment. FIG. 7 shows an example of the inference contribution degree acquired by evaluation calculator 132 according to the present embodiment. FIG. 8A shows a parameter value before quantization calculated by evaluation calculator 132 according to the present embodiment. FIG. 8B shows a parameter value after quantization calculated by evaluation calculator 132 according to the present embodiment. The datasets that are shown in FIGS. 8A and 8B may be the evaluation calculation datasets described above.

C_{L+1} shown in (c) in FIG. 7 is the inference contribution degree of layer L+1 of the FP model shown in (b) in FIG. 7 calculated by inference contribution degree calculator 12 by using the dataset shown in (a) in FIG. 7. That is, evaluation calculator 132 acquires in advance inference contribution degree C_{L+1} shown in (c) in FIG. 7.

Also, evaluation calculator 132 inputs a dataset shown in (a) in FIG. 8A to an FP model shown in (b) in FIG. 8A, and calculates a matrix product value W_{L}X_{L} of weights and neuron values of layer L shown in (c) in FIG. 8A, as a parameter value before quantization.

Likewise, evaluation calculator 132 inputs a dataset shown in (a) in FIG. 8B to an INT model shown in (b) in FIG. 8B, and calculates the following matrix product value of weights and neuron values of layer L shown in (c) in FIG. 8B, as the parameter value after quantization.

Q_{ΔW}(W_{L})Q_{ΔX}(X_{L}) [Math. 1]

Here, Δ represents quantization step size, and Q(⋅) represents quantization function.

Then, evaluation calculator 132 calculates an evaluation result by substituting the calculated parameter values before and after quantization and the acquired inference contribution degree into the following evaluation equation indicated by Equation 1. Then, if the evaluation result obtained by calculation is minimum, evaluation calculator 132 stores the quantization step size at this time. In Equation 1, C represents inference contribution degree C_{L+1} of layer L+1. In Equation 1, W_{L} and X_{L} respectively represent the weights and the neuron values (intermediate values) of layer L. Also, the result of evaluation is a result obtained by accumulating evaluation results calculated for the number of items of data included in the dataset. For this reason, if the average of the evaluation results is minimum, the quantization step size at this time may be stored.

[Math. 2]

(Δw,Δx)=argmin_{ΔW,ΔX}∥C{WX−Q_{ΔW}(W)Q_{ΔX}(X)}∥² Equation 1

### <Quantization Step Size Updater 133>

Quantization step size updater 133 updates the quantization step size value when not all patterns of quantization step size used to calculate the evaluation result have been processed. That is, quantization step size updater 133 repeatedly updates the quantization step size until all patterns have been processed. Quantization step size updater 133 outputs the quantization step size value that has been updated, or in other words, the updated quantization step value to quantization processor 131.

In the manner described above, quantization step size searcher 13 determines the quantization step size by taking into consideration the inference contribution degree and the quantization errors.

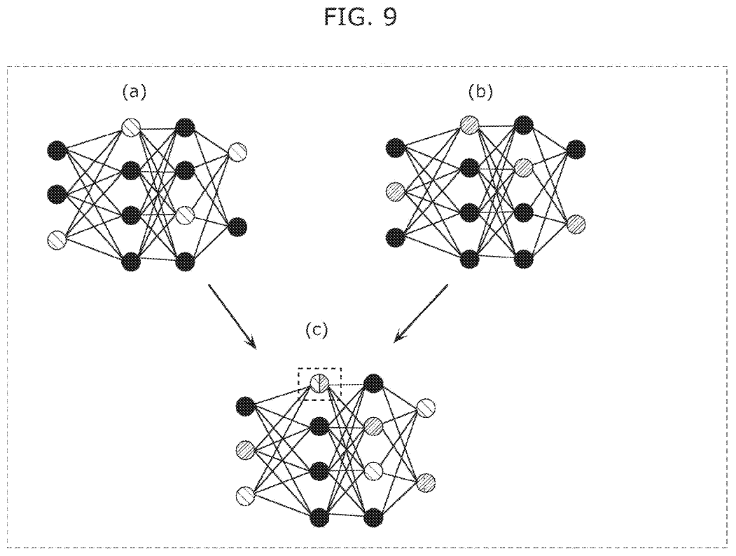

FIG. 9 is a diagram illustrating a method for determining an optimal quantization step size according to the present embodiment. In (a) shown in FIG. 9, neurons with a parameter with a large quantization error are indicated by hatching. In (b) shown in FIG. 9, neurons with a large inference contribution degree are indicated by hatching. In (c) shown in FIG. 9, a neuron with a parameter with a large quantization error and a large inference contribution degree is surrounded by a dotted frame.

That is, in the present embodiment, quantization step size searcher 13 determines the quantization step size of the parameter so as to minimize the quantization error of the parameter of the neuron surrounded by a dotted frame shown in (c) in FIG. 9 that has a parameter with a large quantization error and a large inference contribution degree. By doing so, the degradation in inference accuracy can be prevented even when quantization is performed on the model composed of a neural network.

### [1-4. Quantizer 14]

Quantizer 14 quantizes the plurality of parameters by using the quantization step size obtained as a result of searching performed by quantization step size searcher 13. In other words, quantizer 14 obtains an INT model by quantizing the plurality of parameters of the FP model by using the quantization step size determined as a result of searching performed by quantization step size searcher 13.

### 2. Operation of Quantization Device 10

Hereinafter, a description will be given of an example of an operation performed by quantization device 10 configured as described above.

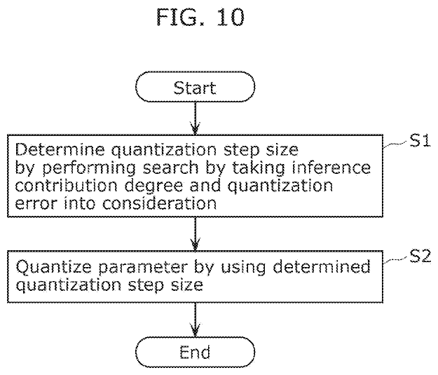

FIG. 10 is a flowchart illustrating an overall operation performed by quantization device 10 according to the present embodiment.

First, quantization device 10 searches for a quantization step size and determines the quantization step size by taking into consideration an inference contribution degree and quantization errors (S1). More specifically, quantization device 10 calculates in advance the inference contribution degree that indicates the degree of influence of a layer next to the target layer that includes a plurality of neurons as elements. Quantization device 10 searches for a quantization step size for a plurality of parameters of the target layer by using the inference contribution degree calculated in advance and the quantization errors before and after quantization of the plurality of parameters of the target layer. In the present embodiment, quantization device 10 searches for a quantization step size for the plurality of parameters by using an evaluation equation composed of a product value of the quantization errors and the second inference contribution degree, such that the evaluation equation is minimized. By doing so, quantization device 10 can determine an optimal quantization step size for the parameters of the target layer of the model.

Next, quantization device 10 quantizes the parameters by using the quantization step size determined in step S1 (S2).

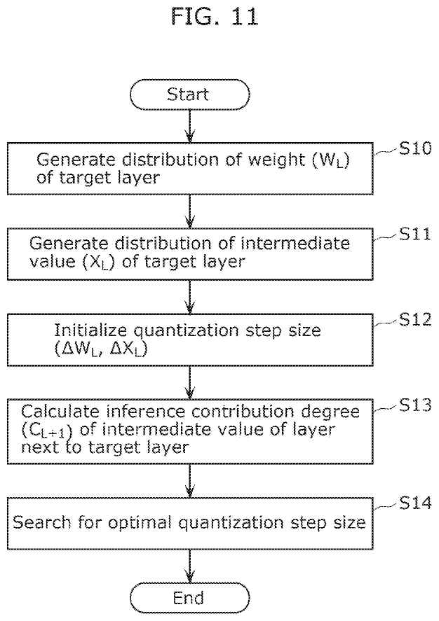

FIG. 11 is a flowchart illustrating an example of a detailed operation performed by quantization device 10 according to the present embodiment. The following description will be given, with the target layer of the FP model that serves as the quantization target being represented by layer L, the weight of the target layer being represented by W_{L}, the intermediate value being represented by X_{L}, and the quantization step sizes for the weight and the intermediate value of the target layer being represented by ΔW_{L} and ΔX_{L}.

As shown in FIG. 11, first, quantization device 10 generates a distribution of weights (W_{L}) of the target layer of the FP model that serves as the quantization target (S10).

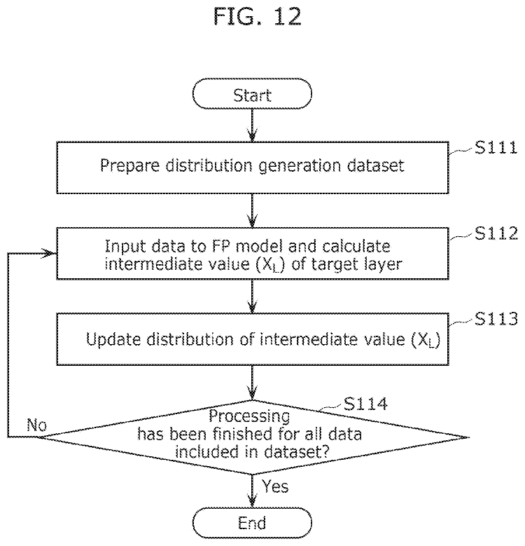

Next, quantization device 10 generates a distribution of intermediate values (X_{L}) of the target layer (S11). Here, a specific operation performed in step S11 will be described with reference to FIG. 12.

FIG. 12 is a flowchart illustrating an example of a specific operation performed in step S11 shown in FIG. 11

As shown in FIG. 12, first, quantization device 10 or a user of quantization device 10 prepares a distribution generation dataset (S111). Next, quantization device 10 inputs one item of data included in the distribution generation dataset to the FP model, calculates the intermediate values (X_{L}) of the target layer (S112), and updates the distribution of the intermediate values (X_{L}) (S113). In the case where quantization device 10 generates the intermediate values (X_{L}) of the target layer for the first time, the generated intermediate values (X_{L}) can be stored. Next, quantization device 10 determines whether processing has been finished for all items of data included in the dataset, or in other words, the intermediate values (X_{L}) of the target layer have been calculated and updated for all items of data included in the distribution generation dataset (S114). If it is determined in step S114 that processing has not been finished for all items of data included in the dataset (No in S114), quantization device 10 returns to step S112, and repeats the processing. On the other hand, if it is determined in step S114 that processing has been finished for all items of data included in the dataset (Yes in S114), quantization device 10 ends the processing, or in other words, step S11. Quantization device 10 does not necessarily need to generate the intermediate value distribution of the target layer, and may generate a feature map distribution of the target layer as described above.

Next, quantization device 10 initializes the quantization step sizes (ΔW_{L} and ΔX_{L}) stored in internal storage 1004 or the like (S12).

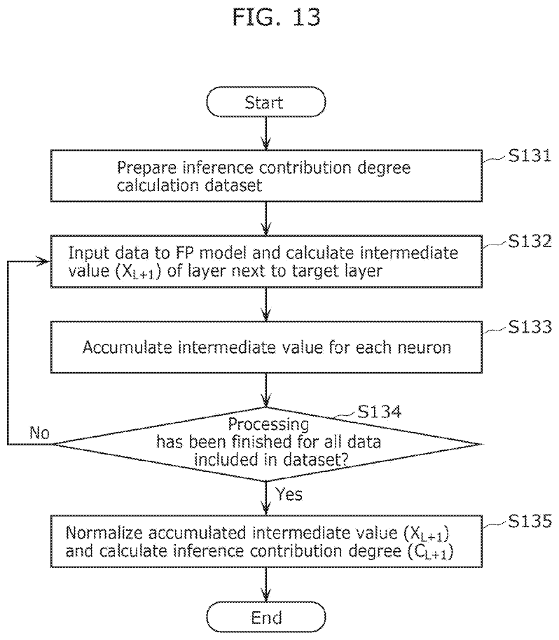

Next, quantization device 10 calculates inference contribution degree (C_{L+1}) of the intermediate values of a layer next to the target layer (S13). Here, a specific operation performed in step S13 will be described with reference to FIG. 13.

FIG. 13 is a flowchart illustrating an example of a specific operation performed in step S13 shown in FIG. 11.

As shown in FIG. 13, first, quantization device 10 or a user of quantization device 10 prepares an inference contribution degree calculation dataset (S131). The inference contribution degree calculation dataset may be the same as the distribution generation dataset described above. Next, quantization device 10 inputs one item of data included in the inference contribution degree calculation dataset to the FP model, calculates intermediate values (X_{L+1}) of the layer next to the target layer (S132), and accumulates the intermediate values (X_{L+1}) for each of the neurons of the next layer (S133). Next, quantization device 10 determines whether processing has been finished for all items of data included in the dataset, or in other words, whether the intermediate values (X_{L+1}) of the layer next to the target layer have been calculated and accumulated for all items of data included in the degree inference contribution degree calculation dataset (S134). If it is determined in step S134 that processing has not been finished for all items of data included in the dataset (No in S134), quantization device 10 returns to step S132 and repeats the processing. On the other hand, if it is determined in step S134 that processing has been finished for all items of data included in the dataset (Yes in S134), quantization device 10 normalizes the intermediate values (X_{L+1}) accumulated in step S113, and calculates the inference contribution degree (C_{L+1}) (S135). Quantization device 10 does not necessarily need to calculate and accumulate the intermediate values of the layer next to the target layer, and may calculate and accumulate feature maps of the layer next to the target layer as described above. The following description will be given by referring back to FIG. 11.

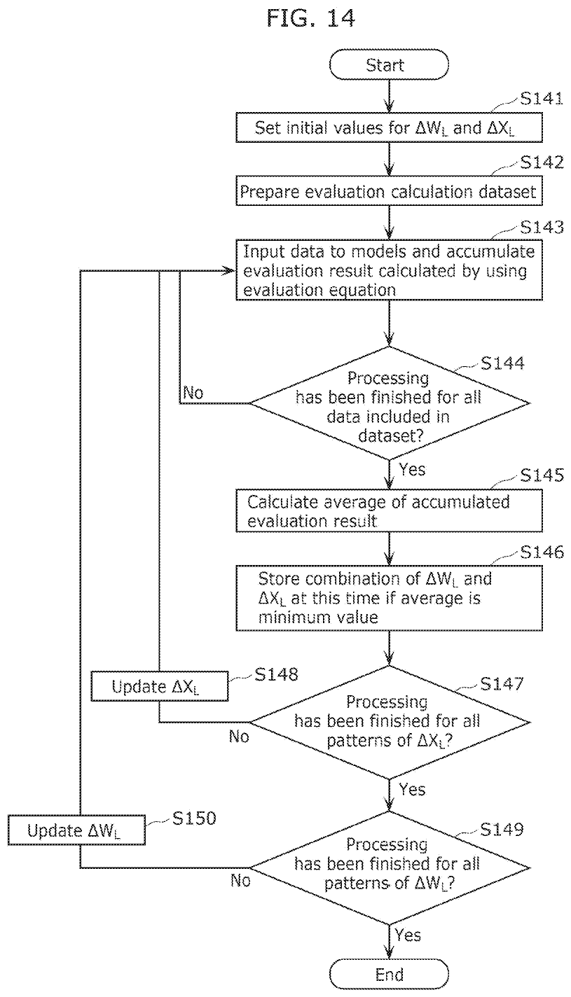

Next, quantization device 10 searches for an optimal quantization step size (S14). Here, a specific operation performed in step S14 will be described with reference to FIG. 14.

FIG. 14 is a flowchart illustrating an example of a specific operation performed in step S14 shown in FIG. 11.

As shown in FIG. 14, first, quantization device 10 sets initial values for ΔW_{L} and ΔX_{L} that indicate quantization step size values (S141). Quantization device 10 or a user of quantization device 10 prepares an evaluation calculation dataset (S142). The evaluation calculation dataset may be the same as the inference contribution degree calculation dataset or the distribution generation dataset described above. Next, quantization device 10 inputs one item of data included in the evaluation calculation dataset to the FP model and the INT model, and accumulates evaluation results calculated by using the evaluation equation indicated by Equation 1 given above (S143). Next, quantization device 10 determines whether processing has been finished for all items of data included in the dataset, or in other words, whether evaluation results calculated by using the evaluation equation indicated by Equation 1 given above have been accumulated for all items of data included in the evaluation calculation dataset (S144).

If it is determined in step S144 that processing has not been finished for all items of data included in the dataset (No in S144), quantization device 10 returns to step S143 and repeats the processing. On the other hand, if it is determined in step S144 that processing has been finished for all items of data included in the dataset (Yes in S144), quantization device 10 calculates the average of the evaluation results accumulated in step S143 (S145). Next, if the average calculated in step S145 is the minimum value, quantization device 10 stores the combination of ΔW_{L} and ΔX_{L} that indicate quantization step size values at this time (S146). Quantization device 10 does not necessarily need to calculate the average in step S145. In this case, in step S146, the combination obtained when the evaluation result is minimum may be stored. Next, quantization device 10 determines whether processing has been finished for all patterns of ΔX_{L} (S147).

If it is determined in step S147 that processing has not been finished for all patterns (No in S147), quantization device 10 updates the quantization step sizes (ΔX_{L}) for intermediate value (S148), and returns to step S143 and repeats the processing. On the other hand, if it is determined in step S147 that processing has been finished for all patterns (Yes in S147), quantization device 10 determines whether processing has been finished for all patterns of ΔW_{L} (S149).

If it is determined in step S149 that processing has not been finished for all patterns (No in S149), quantization device 10 updates the quantization step sizes (AWL) for weight (S150), and returns to step S143 and repeats the processing. On the other hand, if it is determined in step S149 that processing has been finished for all patterns (Yes in S149), quantization device 10 ends the processing, or in other words, step S14.

Next, quantization device 10 quantizes the weights (W_{L}) and the intermediate values (X_{L}) by using the quantization step sizes obtained (determined) as a result of searching performed in step S14 (S2).

In the manner described above, quantization device 10 determines quantization step sizes for the parameters of the model by taking into consideration the inference contribution degree and the quantization errors, and quantizes the parameters of the model.

### 3. Advantageous Effects, Etc.

Here, advantageous effects of the present embodiment will be described with reference to the drawings.

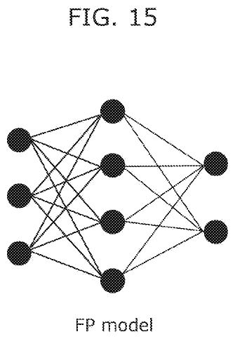

FIG. 15 is a diagram showing an example of a quantization target model. Here, a description will be given by using a trained FP model as shown in FIG. 15 that includes three layers including an input layer composed of three neurons, an intermediate layer composed of four neurons, and an output layer composed of two neurons.

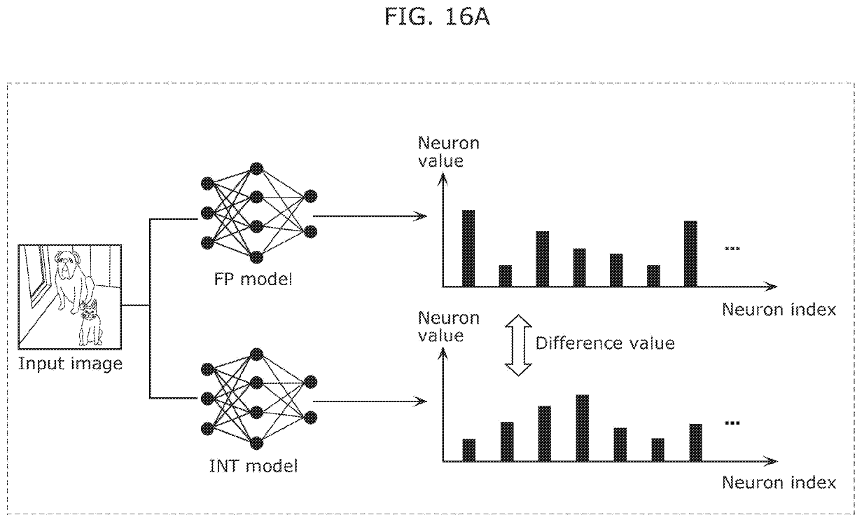

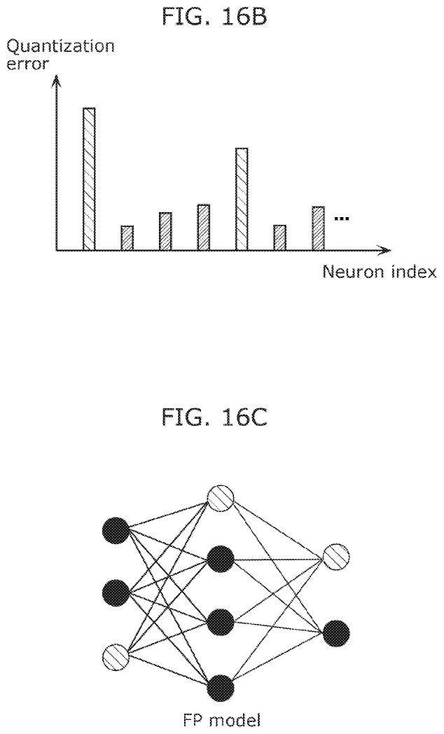

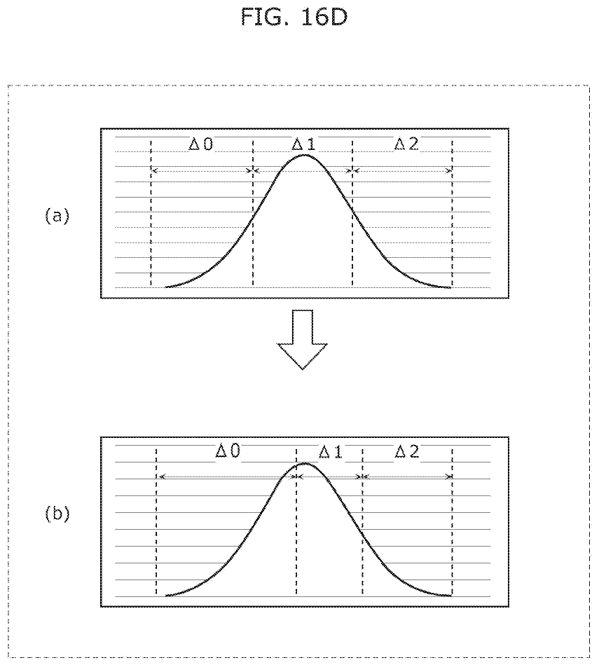

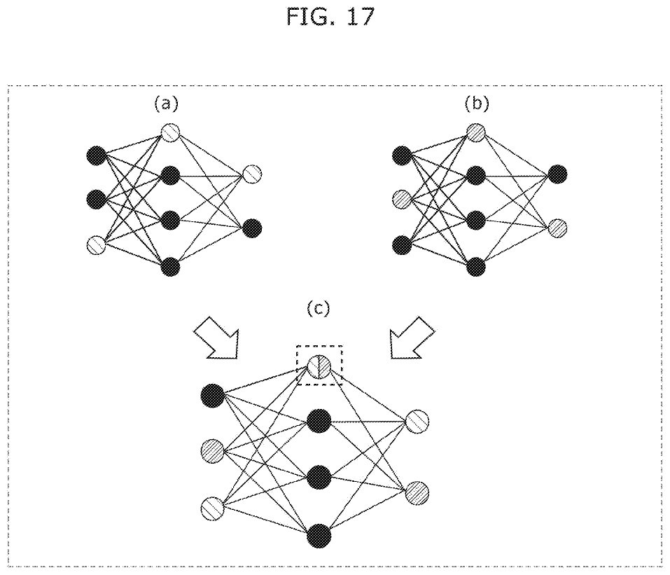

FIGS. 16A to 16D are diagrams illustrating a quantization method according to a comparative example. In the two graphs shown in FIG. 16D, the vertical axis indicates data frequency, and the horizontal axis indicates numerical value.

FIG. 16A shows a first graph in which neuron values obtained by inputting an input image to an FP model are arranged according to the neuro-index. Also, FIG. 16A shows a second graph in which neuron values obtained by inputting the input image to an INT model obtained by quantizing the FP model are arranged according to the neuro-index. The INT model shown in FIG. 16A is an INT model obtained when the FP model is quantized by using an equidistant quantization step size shown in (a) in FIG. 16D. FIG. 16B shows a third graph in which difference values between the first graph and the second graph shown in FIG. 16A as quantization errors are arranged according to the neuro-index.

In a model shown in FIG. 16C, neurons that correspond to neuro-indices with a large quantization error (greater than or equal to a threshold value) are indicated by hatching in the third graph shown in FIG. 16B. That is, it shows that the neurons indicated by hatching in the FP model shown in FIG. 16C have a large error (quantization error) generated as a result of quantization.

In the comparative example, among the neurons included in the model, with respect to the quantization errors generated as a result of quantization, an individual quantization step size is determined so as to minimize the quantization error shown in (b) in FIG. 16D, instead of the equidistant (division in equal parts) quantization step size shown in (a) in FIG. 16D.

However, even when the parameters of the neurons with a large quantization error are specified and an individual quantization step size is determined so as to minimize the quantization error, it is not necessarily possible to prevent the degradation of the inference accuracy.

FIG. 17 is a diagram conceptually illustrating the quantization method according to the present embodiment.

On the other hand, in the present embodiment, the parameters of the FP model are quantized by determining the quantization step sizes of the parameters of the FP model by taking the inference contribution degree and the quantization errors into consideration.

More specifically, with respect to the neurons included in the target layer of the FP model, not only the quantization errors generated as a result of quantization, but also the contribution degree of the result of inference (or in other words, inference contribution degree) are calculated. Then, by using the quantization method that takes both the quantization errors and the inference contribution degree into consideration, an optimal quantization step size is determined. That is, in the quantization method according to the present embodiment, hatched neurons with a large quantization error as shown in (a) in FIG. 17 and hatched neurons with a large inference contribution degree as shown in (b) in FIG. 17 are derived. Then, as shown in (c) in FIG. 17, the parameters of a neuron with a large quantization error and a large inference contribution degree, the neuron being surrounded by a dotted frame, is determined so as to minimize the quantization error of the neuron.

By doing so, the step size can be determined so as to minimize the quantization error of a neuron with a large inference contribution degree, and thus the degradation in inference accuracy can be prevented even when quantization is performed on the model composed of a neural network.

Accordingly, even when inference is performed by using limited calculation resources such as an embedded system, it is possible to implement inference processing in deep learning that achieves both the inference accuracy and the amount of computation (processing speed).

The inference accuracy is not limited to a precision and a recall in the case where an output value of a quantized model indicates whether the correct answer has been inferred, and may be at least one combination of a precision, a recall, an F value calculated from a harmonic mean of the precision and the recall, and an accuracy rate.

Also, the present disclosure has been described by using an embedded system as an example in which inference is performed by using limited calculation resources. However, the present disclosure is not limited thereto. The present disclosure is applicable to not only the case where inference is performed in a system mounted on a vehicle such as an in-vehicle system, but also to the case where inference is performed in a system mounted on a drone. Also, the model according to the present disclosure is not limited for use in identification, detection and segmentation that use images, and may be used in speaker identification and detection that use sound.

### Other Embodiments

Up to here, the quantization method and the like according to the present disclosure have been described by way of the embodiment. However, the present disclosure is not limited to the embodiment given above. Other embodiments obtained by making various modifications that can be conceived by a person having ordinary skill in the art to the above embodiment as well as embodiments implemented by any combination of the structural elements of the above embodiment without departing from the scope of the present disclosure are also included in the scope of the present disclosure.

Also, embodiments given below may also be included in the scope of one or more aspects of the present disclosure.

(1) Some of the structural elements that constitute the quantization device described above may be a computer system that includes a microprocessor, a ROM, a RAM, a hard disk unit, a display unit, a keyboard, a mouse, and the like. A computer program is stored in the RAM or the hard disk unit. As a result of the microprocessor operating in accordance with the computer program, the functions thereof are implemented. Here, the computer program is composed of a combination of a plurality of instruction codes that indicate instructions for the computer to implement the predetermined functions.

(2) Some of the structural elements that constitute the quantization device described above may be a single system LSI (Large Scale Integration). The system LSI is a super multifunctional LSI manufactured by integrating a plurality of structural elements on a single chip, and is specifically a computer system that includes a microprocessor, a ROM, a RAM, and the like. A computer program is stored in the RAM. The functions of the system LSI are implemented as a result of the microprocessor operating in accordance with the computer program.

(3) Some of the structural elements that constitute the quantization device described above may be composed of an IC card or a single module that can be attached and detached to and from the device. The IC card or the module is a computer system that includes a microprocessor, a ROM, a RAM, and the like. The IC card or the module may include the above-described super multifunctional LSI. The functions of the IC card or the module are implemented as a result of the microprocessor operating in accordance with a computer program. The IC card or the module may have tamper resistance.

(4) Also, some of the structural elements that constitute the quantization device described above may be implemented by being recorded in a recording medium that can read a computer program or a digital signal by using a computer, such as, for example, a flexible disc, a hard disk, a CD-ROM, a MO, a DVD, a DVD-ROM, a DVD-RAM, a BD (Blu-ray® Disc), or a semiconductor memory. Also, some of the structural elements that constitute the quantization device described above may be implemented by a digital signal recorded in any of the recording media.

Also, some of the structural elements that constitute the quantization device described above may be implemented by transmitting the computer program or the digital signal via a telecommunication line, a wireless or wired communication line, a network as typified by the Internet, data broadcasting, or the like.

(5) The present disclosure may be the method described above, or may be a computer program that implements the method by using a computer, or may be a digital signal of the computer program.

(6) Also, the present disclosure may be a computer system that includes a microprocessor and a memory. The memory may store the computer program described above, and the microprocessor may operate in accordance with the computer program.

(7) Alternatively, the present disclosure may be implemented by another independent computer system by recording the program or the digital signal on any of the recording media described above and transferring the program or the digital signal, or by transferring the program or the digital signal via a network or the like.

(8) The embodiments and variations described above may be combined.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings and claims is incorporated herein by reference in its entirety: No. 2021-050388 filed on Mar. 24, 2021.

### INDUSTRIAL APPLICABILITY

The present disclosure is applicable to a quantization method for quantizing a model composed of a neural network used to perform inference by using limited calculation resources such as an embedded system, a quantization device, a recording medium, and the like.

1. A quantization method executed by a computer, the quantization method comprising:
searching for quantization step sizes of a plurality of parameters of a target layer by using a second inference contribution degree and quantization errors before and after quantization of the plurality of parameters of the target layer, the second inference contribution degree indicating a degree of influence of a layer next to the target layer and being obtained using a first inference contribution degree calculated in advance, the layer next to the target layer including a plurality of second neurons as elements, the first inference contribution degree indicating a degree of influence of each of a plurality of layers that constitute a model composed of a neural network and each include a plurality of first neurons as elements on an inference result obtained by using the model, and the target layer and the layer next to the target layer being included in the plurality of layers; and
quantizing the plurality of parameters by using the quantization step sizes obtained as a result of the searching.

2. The quantization method according to claim 1,
wherein the searching for the quantization step sizes of the plurality of parameters is performed by using an evaluation equation including a product value of the quantization errors and the second inference contribution degree such that the evaluation equation is minimized.

3. The quantization method according to claim 1, further comprising:
calculating first neuron values of the first neurons by performing inference by inputting, to the model, each item of data that constitutes an inference contribution degree calculation dataset that is at least a portion of a training dataset used to train the model;
calculating, for each of the first neurons, an accumulated value by accumulating the first neuron values calculated for all items of the data that constitutes the inference contribution degree calculation dataset; and
calculating, as the first inference contribution degree, a value obtained by normalizing the accumulated value of each of the first neurons for each of the plurality of layers.

4. The quantization method according to claim 1,
wherein the plurality of parameters are at least either a plurality of intermediate values of the target layer or a plurality of weights assigned to the second neurons.

5. The quantization method according to claim 4,
wherein the model is a convolutional neural network, and
the intermediate values are feature maps of the target layer.

6. A quantization device comprising:
a processor; and
a memory,
wherein the processor performs the following by using the memory:
searching for quantization step sizes of a plurality of parameters of a target layer by using a second inference contribution degree and quantization errors before and after quantization of the plurality of parameters of the target layer, the second inference contribution degree indicating a degree of influence of a layer next to the target layer and being obtained using a first inference contribution degree calculated in advance, the layer next to the target layer including a plurality of second neurons as elements, the first inference contribution degree indicating a degree of influence of each of a plurality of layers that constitute a model composed of a neural network and each include a plurality of first neurons as elements on an inference result obtained by using the model, and the target layer and the layer next to the target layer being included in the plurality of layers; and
quantizing the plurality of parameters by using the quantization step sizes obtained as a result of the searching.

7. A non-transitory computer-readable recording medium for use in a computer, the recording medium having a computer program recorded thereon for causing the computer to execute:
searching for quantization step sizes of a plurality of parameters of a target layer by using a second inference contribution degree and quantization errors before and after quantization of the plurality of parameters of the target layer, the second inference contribution degree indicating a degree of influence of a layer next to the target layer and being obtained using a first inference contribution degree calculated in advance, the layer next to the target layer including a plurality of second neurons as elements, the first inference contribution degree indicating a degree of influence of each of a plurality of layers that constitute a model composed of a neural network and each include a plurality of first neurons as elements on an inference result obtained by using the model, and the target layer and the layer next to the target layer being included in the plurality of layers; and
quantizing the plurality of parameters by using the quantization step sizes obtained as a result of the searching.
